(19) United States
(12) Patent Application Publication
(10) Pub. No.: US 2006/0014908 A1
(43) Pub. Date: Jan. 19, 2006

(54) Foam material consisting predominantly of carbon having a high inner surface and method for the production thereof

(75) Inventors: Udo Rotermund, Ortrand (DE); Renate Hempel, Ruhland (DE); Michael Hesse, Worms (DE); Jan Rudloff, Desden (DE); Maryline Desseix, Melle (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/526,930

(22) PCT Filed: Sep. 8, 2003
(86) PCT No.: PCT/EP03/09943

§ 371 Date: Mar. 8, 2005

(30) Foreign Application Priority Data
Sep. 17, 2002 (DE) 102 43 240.6

(51) Int. Cl. C08G 18/02; C08G 18/06

(52) U.S. Cl. 525/452

(57) ABSTRACT

The invention relates to a foam comprising at least 70% by weight of carbon and having a mean cell size above 20 μm, a porosity based on this cell size of from 35% to 99.5% and an open cell content above 90%, an internal surface above 50 m²/g, having cell struts whose cross section is a triangle having concave sides and having pores in the cell framework material having dimensions of from 0.2 nm to 50 nm and a volume of from 0.01 cm³/g to 0.8 cm³/g, and also to its use. It further relates to a process for producing a foam comprising at least 70% by weight of carbon by pyrolysis of polymer foams which comprise at least 30% by mass of a polymer material having a nitrogen content of more than 6% by mass and having a porosity of from 35 to 99.5% and an open cell content above 1%, have inorganics incorporated into the polymer foam and/or applied to the surface and/or are treated during and/or after the pyrolysis with water vapor and/or carbon dioxide and/or oxygen at above 400° C.

The present invention relates to foams having a high internal surface area and comprising at least 70% by weight of carbon, and also to a process for producing them by pyrolysis of polymer foams.

Foams which are composed predominantly of carbon and are also known as carbon foams are of interest for various applications because of the materials properties of carbon. Thus, for example, U.S. Pat. No. 4,067,956 and Sherman, A. J., Tuffias, R. H. and Kaplan, R. B. (1991) Ceramic Bulletin, 70, 1025-1029, disclose their use as filter material, including high-temperature applications, as high-temperature thermal insulation, as catalyst supports and as electrode material in batteries. The literature also mentions the use of carbon foams as electrode material in high-performance capacitors (e.g. U.S. Pat. No. 5,300,272), for medical implants (WO-A-98/02382), as supports for, for example, materials which absorb heat by means of a solid/liquid transition, including their use at relatively high temperatures (WO-A-99/64223), as column material for chromatography (DE-A-3135394) or as electrode material for enzyme electrodes (Blaedel, W. J. and Wang, Joseph (1980), Anal. Chem. 52, 1426-1429).

Apart from these applications, carbon foams are also used for producing high-performance materials: EP-A-581696 describes the production of a carbon/carbon composite material from a porous structure which is produced from a compressed carbon fiber material by impregnation with a heavy hydrocarbon. This carbon/carbon composite is used as friction material for brake disks having a particularly high effectiveness. In WO-A-98/27023, carbon foam is used directly for the same application. According to EP-A-0976698, a porous carbon layer having an open cell content of from 40 to 95% is, for example, impregnated with molten silicon and subsequently cooled to room temperature. Applications of the resulting composite are likewise brake and clutch disks for vehicles.

The following methods have hitherto been known for producing carbon foams:

1. Impregnation of open-celled polyurethane foam Impregnation is carried out using materials which give a high carbon yield in the subsequent pyrolysis at temperatures above 500° C., usually above 800° C. or even far above 1000° C. Such impregnants are, for example, thermally curing resins, usually phenolic resin, or a mixture of such a resin with pitch, usually “mesophase pitch”. The process of impregnation of open-celled polyurethane foam and subsequent pyrolysis is described, for example, in U.S. Pat. No. 4,067,956, U.S. Pat. No. 3,922,334, WO-A-98/02382, WO-A-00/15576 and U.S. Pat. No. 6,040,266.

This process has the advantage that, externally, the good cell structure of the polyurethane foams is carried over to the carbon foam. However, the structure of a single strut of the cells of the foam after impregnation of the polyurethane foam is that of a polyurethane strut surrounded by a layer of impregnant. Impregnation of the polyurethane foam is thus not a penetration of the compact polyurethane cell struts with the impregnant, but a coating of the surface of the struts. On thermal curing of this composite (Aoki, Y. and McEnaney, B. report, for example in British Ceramic Transactions, 94, 133-37 (1995), a temperature of 160° C.), solvent used evaporates first and curing of the resin takes place. The polyurethane material subsequently decomposes in the pyrolysis to form gaseous substances. Aoki, Y. and McEnaney, B., in British Ceramic Transactions, 94, 133-37 (1995), state that the proportion of the polyurethane remaining as carbon at 1200° C. is about 3%, and that of the phenolic resin used for impregnation is about 50%. The gaseous pyrolysis products of the polyurethane thus escape from the strut through the carbon wall being formed from the resin. The result is struts which are hollow in their interior in the carbon foam. In addition, the structure of the strut walls is destroyed by the escape of the comparatively large quantities of pyrolysis products of the polyurethane. Thus, although a carbon foam which externally displays the good foam structure of the polyurethane foam is formed, it is damaged by hollow struts and strut walls whose structure has been destroyed. This structure is associated with, for example, a loss in strength. Even more recent inventions based on this process, e.g. WO-A-00/15576 and U.S. Pat. No. 6,040,266, represent such a structure, associated with nonoptimum properties of the carbon foams formed.

2. Pyrolysis of aerogels of organic polymers to give carbon foam The aerogels of organic polymers are produced, for example according to WO-A-93/14511, by reaction of formaldehyde and resorcinol in aqueous sodium carbonate solution for 24 hours at room temperature, then 24 hours at 50° C. and subsequently 72 hours at 95° C. The gel formed is washed with a 0.1% strength solution of trifluoroacetic acid in acetone and then with pure acetone. It is subsequently treated with liquid CO₂ at 63 bar (900 psi) and 14° C. for 1 hour, then with fresh CO₂ in each case for 15 minutes 6 times per day for 2 days, and finally in a closed vessel under supercritical conditions at 50° C. and 127 bar (1800 psi) for 4 hours and with stepwise reduction of the pressure over 8 hours to give a dried aerogel. This is followed by pyrolysis at from 600 to 1200° C. to give a carbon foam. Analogously complicated methods of producing carbon foams are described in the following publications: Journal of Non-Crystalline Solids, 225, 64-68, and WO-A-98/44013 (both 1998, organic basis in each case isocyanate adducts), Polym. Prepr., Am. Chem. Soc., Div. Polym. Chem., 37(2)., 777-778 (1996, organic basis Friedel-Crafts adducts), U.S. Pat. No. 5,300,272, U.S. Pat. No. 5,268,395, U.S. Pat. No. 5,358,802, Polym. Mater. Sci. Eng., 57, 113-117 and WO-A-95/06002 (organic basis in each case polyacrylonitrile), Polym. Mater. Sci. Eng., 57, 113-117 (polyacrylonitrile with maleic anhydride), EP-A-0987294 (organic basis polyimide), WO-A-99/01502, U.S. Pat. No. 5,4201,68, U.S. Pat. No. 5,529,971, U.S. Pat. No. 4,997,804 and U.S. Pat. No. 5,402,306 (organic basis resorcinol-formaldehyde condensates), U.S. Pat. No. 4,992,254, U.S. Pat. No. 5,047,225 and U.S. Pat. No. 5,232,772 (organic basis styrene, divinylbenzene, resorcinol, formaldehyde, “carbonized polystyrene-resorcinol (CPR)-formaldehyde foam”.

The structure of such carbon foams having extremely small cells far below 30 μm, often significantly below 1 μm, is unsuitable for many applications, e.g. because of the very high flow resistance when used as filter material, as catalyst supports, as supports for materials or as reactive components for producing composite materials, e.g. by reaction with silicon or further carbon. In addition, the production of this extremely fine-celled structure is cumbersome and time-consuming. As a result, materials having this foam structure are not only unsuitable for many applications but also have the disadvantage of incurring very high production costs.

3. Foaming of C-containing material at relatively high temperature and subsequent firing

A frequently described variant is foaming of pitch, e.g. as described in WO-A-99/11585, WO-A-99/61549, EP-A-0700106. The disadvantage of the resulting foam structures is the proportion of open cells which is too low at significantly below 90%, as indicated by the values reported, for example, in U.S. Pat. No. 4,276,246. The cause is the complicated foaming process at elevated temperature. This also applies to foam structures which are, as described in WO-A-99/65843, formed in an analogous manner from pitch in admixture with curable liquid resins. When biogenic materials are used, porous carbon bodies are likewise formed on pyrolysis, e.g. as described in WO-A-99/11581. By their nature, these bodies do not have an actual foam structure and are therefore unsuitable for most applications of carbon foams.

4. Filling of a matrix with organic material, then firing and, if appropriate, removal of the matrix material

According to Pekala., R. W. & Hopper, R. W. (1987), Low-density microcellular carbon foams, Journal of Materials Science, 22, 1840-1844, compacts of finely particulate sodium chloride are, for example, impregnated with phenolic resin for this purpose. After curing of the phenolic resin, the sodium chloride is leached out using water. The resulting porous structure is then dried and pyrolyzed. The resulting structure represents the voids of a pressed powder bed. As a result of the necessary close contact of the particles of the sodium chloride powder, this structure has a large number of places to which the polymer material cannot get, so that the structure formed after leaching has a correspondingly large number of weak points. This results in very low strengths which are also reflected in the strengths of the carbon foam formed after pyrolysis. The compressive strength of the carbon foam at a density of 50 mg/cm³ of only 0.00011 MPa reported by the authors confirms this disadvantage of the resulting foam structure, which is also formed analogously by the method described in, for example, DE-A-3135394.

The impregnation of phenolic resin microspheres or carbon microspheres with a carbonized resin is described by Benton, S. T. & Schmitt, C. R. in (1972), Carbon, 10, 185. The composite formed is pyrolyzed at 900 and 2150° C. The resulting carbon foam has good compressive strengths, e.g. 452 lb/in² (3.2 N/mm²) at 170 kg/M³, but has only a very low open cell content and is thus not usable for many applications. Apart from the insufficient open cell content, the carbon foam structure has the disadvantage that densities below 150 kg/M³ cannot be achieved.

5. Porous carbon materials produced from carbon fiber structures

The porous structures are used for producing a dense carbon material, e.g. for disk brakes. According to WO-A-00/39043, carbon fibers are impregnated with a carbonizable liquid at elevated temperature and superatmospheric pressure. Sudden depressurization and quenching gives a foam structure which is pyrolyzed at from 600 to 1000° C. and, if appropriate, after-treated at from 2200 to 2300° C. The use of carbon fibers as starting material is, apart from their complicated production, very costly and these fibers prevent formation of a regular foam structure. A similar process having the same disadvantages is described in EP-A-581696.

6. Pyrolysis of polymer foams

This method is utilized by, for example, ZHOU Jia-hong, XUE Kuan-hong, XU Shi-min, SUN Dong-mei, & GU Wei-jin (2000) in Chinese Journal of Power Sources 24 (3), 157-158, 177. However, the structure of carbon foams derived from polyurethane foam as used by the authors displays inhomogeneities, e.g. in the form of cracks or high-density regions, which have an adverse effect on, inter alia, the mechanical properties. Such unfavorable structures are also obtained in the previously known direct pyrolysis of other polymer foams.

According to our own patent application No. 101 56 132.6, which is not a prior publication, it is possible to produce carbon foams which no longer have the deficiencies described under 1. to 6., e.g. low strengths, excessively high flow resistances or excessively complicated and thus costly production methods. Unfortunately, the internal surface area of these foams is always less than 50 m²/g, usually less than 30 m²/g and very often less than 20 m²/g. This low internal surface area is a disadvantage for many applications, e.g. for use as electrode material for supercapacitors, which require a material having a high internal surface area.

It is an object of the present invention to produce a carbon foam which has the advantages of the foam described in the DE application No. 101 56 132.6 and also has a high internal surface area which is at the same time readily accessible.

We have found that this object is achieved by producing a foam comprising at least 70% by weight of carbon by pyrolysis of polymer foams which comprise at least 30% by mass of a polymer material having a nitrogen content of more than 6% by mass and have a porosity of from 35 to 99.5% and an open cell content above 1% and generating an internal surface area of over 50 m²/g by the action of inorganics incorporated into the polymer foam and/or present on the surface and/or of water vapor and/or carbon dioxide and/or oxygen during the thermal treatment. In addition, this foam consisting predominantly of carbon has a mean cell size above 20 μm, a porosity based on this cell size of from 35 to 99.5% and an open cell content above 90% and has cell struts whose cross section is a triangle having concave sides and has pores in the cell framework material having dimensions of from 0.2 nm to 50 nm and a volume of from 0.01 cm³/g to 0.8 cm³/g.

The present invention accordingly provides a foam comprising at least 70% by weight of carbon and having a mean cell size above 20 μm, a porosity based on this cell size of from 35 to 99.5% and an open cell content above 90%, an internal surface area above 50 m²/g, having cell struts whose cross section is a triangle having concave sides and having pores in the cell framework material having dimensions of from 0.2 nm to 50 nm and a volume of from 0.01 cm³/g to 0.8 cm³/g, and also provides for the use of such foams consisting predominantly of carbon for electrical and electrochemical applications, especially as electrode material for supercapacitors, and in fuel cells, as filter and thermal insulation material, as support and storage material and as starting material for further reactions.

The invention further provides a process for producing a foam comprising at least 70% by weight of carbon by pyrolysis of polymer foams which comprise at least 30% by mass of a polymer material having a nitrogen content of more than 6% by mass and having a porosity of from 35 to 99.5% and an open cell content above 1%, have inorganics incorporated into the polymer foam and/or applied to the surface and/or are treated during and/or after the pyrolysis with water vapor and/or carbon dioxide and/or oxygen at above 400° C.

The novel foam consisting predominantly of carbon comprises at least 70% by weight, preferably from 75 to 99.5% by weight and particularly preferably from 80 to 99% by weight, of carbon. Its mean cell size is above 20 μm, preferably above 50 μm, and its 45 porosity based on this cell size is from 35 to 99.5%, preferably from 60 to 98%, particularly preferably from 70 to 97%. The carbon foam has an open cell content, likewise based on this cell size, of above 90%, preferably above 93%.

The majority of the cell struts of the carbon foam body have a cross section which can be described as a triangle having concave sides. The cell framework material has pores having dimensions of from 0.2 nm to 50 nm, preferably from 0.5 nm to 20 nm, particularly preferably from 0.8 nm to 10 nm, and having a volume of from 0.01 cm³/g to 0.8 cm³/g, combined with a large internal surface area of above 50 m²/g, preferably above 150 m²/g, particularly preferably above 300 m²/g, for particular applications above 500 m²/g, in specific cases above 1000 m²/g.

Furthermore, the carbon foam has a hydrogen content of preferably below 3% by mass, in particular below 2% by mass, and a nitrogen content of preferably above 0.01% by mass, preferably above 0.05% by mass, in particular cases above 1% by mass.

The framework material of the carbon foam preferably has a density of from 0.8 to 2.3 g/cm³, particularly preferably from 1.2 to 2.0 g/cm³. The density of the framework material depends on the structure of the carbon and the proportion of pores having dimensions in the range from 0.2 to 50 nm. The structure of the carbon can be predominantly vitreous/X-ray-amorphous with a relatively low density or predominantly graphite-like/X-ray-crystalline with a relatively high density. The proportion of graphite-like/X-ray-crystalline materials increases with the pyrolysis temperature. Pyrolysis temperatures of from about 500° C. to about 1200° C. result in X-ray-amorphous carbon foams, while higher temperatures give foams having an X-ray crystallinity which increases with the temperature.

The framework material of the carbon foam can have electrical conductivities of from 10⁻¹⁰ S/cm to 5000 S/cm, preferably from 10⁻⁵ S/cm to 1000 S/cm and particularly preferably from 10⁻² S/cm to 500 S/cm. The conductivity can be set by selection of the pyrolysis temperature. For example, carbon foams having an extremely low electrical conductivity are formed at about 500° C., but temperatures around 2300° C. give foams having a high conductivity which can be further increased by increasing the duration of the heat treatment and by incorporating graphite into the polymer foam before the pyrolysis. Intermediate conductivities which depend on the temperature can be obtained at temperatures in between.

In place of graphite, it is also possible to add substances which are readily converted into graphite during the pyrolysis. An example of such a substance is mesophase pitch, as produced, for example, by Mitsubishi as Mitsubishi ARA-24 Mesophase Pitch.

The framework material of the carbon foam of the present invention also displays a signal measured by solid-state ¹³C nuclear magnetic resonance spectroscopy in the range from 100 ppm to 200 ppm which makes up over 95 percent by area of the spectrum.

The foam comprising at least 70% by weight of carbon can be converted into a powder form by mechanical comminution, which is advantageous for particular applications. Mechanical comminution can be carried out in any known way. A ball mill is particularly useful. Apart from the above-described properties, the pulverulent carbon material has a maximum particle size of less than 1000 μm, preferably less than 500 μm, particularly preferably less than 100 μm.

The novel foams comprising at least 70% by weight of carbon can be produced by pyrolysis of polymer foams. The polymer foams used comprise at least 30% by mass of a polymer material or a mixture of a plurality of polymer materials having a nitrogen content above 6% by mass, preferably above 8% by mass and particularly preferably above 9% by mass, and a porosity in the range from 35 to 99.5% and also an open cell content above 1%, preferably above 30% and particularly preferably above 70%.

Such polymer materials are preferably ones which are or comprise urea-formaldehyde resins, melamine-formaldehyde resins or polymeric isocyanate adducts.

The urea-formaldehyde resins and melamine-formaldehyde resins used are prepared by known methods of the prior art. An example of such a foam is the melamine-formaldehyde foam Basotect® from BASF Aktiengesellschaft.

Particularly preferred polymer materials are ones which comprise polymeric isocyanate adducts. These polymeric isocyanate adducts advantageously contain polyisocyanurate structures which have a ratio Aᵣ Of the absorbance of the isocyanurate band in the mean infrared region at about 1410 cm⁻¹ recorded using the pressed potassium bromide pellet technique after preparation to the absorbance of the aromatic bands at about 1600 cm⁻¹ of greater than 1.5. Preference is given to using foams having values above 3, particularly preferably above 4.5. The indicated wavelengths of 1410 cm⁻¹ for the isocyanurate structure and 1600 cm⁻¹ for the aromatic structure are the values for the maxima of the bands. These values can, as is known to those skilled in the art, fluctuate by ± 20 cm⁻¹ in each case as a result of the preparation of the sample and, for example, as a function of the substitution pattern of the aromatics. For the purposes of the present invention, the expressions “isocyanurate band in the middle infrared region at about 1410 cm⁻¹” and “aromatics band at about 1600 cm⁻¹” reflect this fluctuation.

The polymeric isocyanate adducts are prepared in a customary way by reaction of polyisocyanates with themselves, with compounds containing hydrogen-active groups or with further compounds which react with isocyanate in the presence of catalysts, stablizers, blowing agents and, if desired, further auxiliaries. Polyisocyanates used are, for example, isomers of tolylene diisocyanate, preferably isomers of diphenylmethane diisocyanate, particularly preferably a mixture of isomers of diphenylmethane diisocyanate and polyphenyl polyisocyanates of various degrees of condensation.

It is also possible to use other polyisocyanates customary in polyurethane chemistry, as are described, for example, in WO 00/11059.

As compounds containing hydrogen-active groups, it is possible to use, in particular, hydroxyl-containing polymerization products having a molar mass greater than 200 g/mol, preferably greater than 500 g/mol and particularly preferably greater than 1000 g/mol, and a functionality greater than 1, preferably greater than 2.

It is advantageous to use compounds containing ether structures which are preferably obtained in a known manner by polymerization of alkylene oxides, preferably ethylene oxide and/or propylene oxide, and starter substances containing hydrogen-active groups.

It can also be advantageous to employ polyesterols based on aromatic polycarboxylic acids and polyfunctional alcohols, preferably aromatic ester structures, as hydrogen-active compounds.

Further suitable compounds containing hydrogen-active groups are such materials described in the specialist and patent literature, for example in WO 00/11059.

Apart from the hydrogen-active compounds, it is also possible to use further compounds which react with isocyanate. Examples of such compounds are compounds having organic anhydride groups which react to form imide structures and compounds containing epoxide groups which react to form oxazolidinone structures. Apart from the imide and oxazolidinone structures, the minimum amounts of isocyanurate structures described above by the ratio Aᵣ have to be present in the polymer foam.

The reaction of the polyisocyanates and compounds containing hydrogen-active groups is carried out in the presence of catalysts. The catalysts customary in polyurethane chemistry, as are described, for example, in WO 00/11059, are used for this purpose. These catalysts, e.g. amines, are usually supplemented or replaced by alkali metal salts, especially potassium salts, and/or triazines, especially for the formation of isocyanurate structures. According to the present invention, at least one compound having a crown ether structure, for example 1,4,7,10,13,16-hexaoxacyclooctadecane (“18-crown-6”) is advantageously used as cocatalyst.

Apart from the above-described polyisocyanates, compounds containing hydrogen-active groups and catalysts, further compounds such as stabilizers, blowing agents and other auxiliaries and additives are added in the preparation of the polymeric isocyanate adducts. The compounds customary in polyurethane chemistry, as are described, for example, in WO 00/11059, may be used for this purpose. It is advantageous to use organosilicon compounds, in particular polyether siloxanes, as stabilizers, and air and/or nitrogen and/or CO₂ and/or water and/or vaporizable organic liquids, for example n-pentane, isopentane and/or cyclopentane, as blowing agents. It is advantageous to use the CO₂ formed by the reaction of water with isocyanate, either alone or in combination with a pentane. Other auxiliaries and additives which have been found to be useful are, for example, substances having a low viscosity for improving the flowability, which are incorporated in the polymer, e.g. furfuryl alcohol, or which promote carbonization in the subsequent pyrolysis, e.g. triethyl phosphate. It is advantageous to make concomitant use of fillers having a high carbon content, e.g. carbon black and/or graphite.

To generate the pores having dimensions of from 0.2 nm to 50 nm and a high internal surface area as specified according to the present invention in the cell framework material, it is advantageous to incorporate inorganic fillers into the polymer foams which are subsequently pyrolyzed. Such fillers are, in particular, inorganic salts, preferably zinc chloride, calcium carbonate, ammonium polyphosphate, either alone or as any mixture, and/or expanded graphite and/or metal powder, for example zinc dust and/or aluminum powder. The inorganic materials are advantageously used in an amount of from 0.1 to 60% by mass, preferably from 0.5 to 40% by mass, particularly preferably from 1 to 25% by mass, in each case based on the total mass of the carbon foams.

In the case of the polymer foams based on isocyanate, the incorporation of these materials is achieved particularly simply by mixing into one of the liquid components which are used for the synthesis. However, the polymer foams used can also be impregnated with solutions or dispersions of inorganic salts, metal powders or expanded graphite in water or organic solvents, advantageously in such a way that an amount of from 0.1 to 60% by mass, preferably the abovementioned amounts, of the inorganics remains on the foam after evaporation of the solvents. The two measures, viz. incorporation or application of the inorganics, can also be employed in combination.

The polymer foams used for producing the carbon foams of the present invention have an open cell content of more than 1%, preferably more than 30% and particularly preferably more than 70%. The desired open cell content is advantageously produced using liquid, relatively high molecular weight, unsaturated hydrocarbons such as polybutadiene or polyoctenylene, as is described, for example, in DE-A-4303809.

The nitrogen content of the polymer foams is above 6% by mass, preferably above 8% by mass and particularly preferably above 9% by mass. In the case of the isocyanate adducts, it is determined by the amount of MDI in the formulation. Pure MDI has a nitrogen content of 11.2% by mass. In the case of the urea-formaldehyde resins and the melamine resins, the nitrogen contents are, as is known, always above 6% by mass.

The porosity of the polymer foams used is in the range from 35 to 99.5%. The porosity can be calculated from the density of the foam and of the cell framework material (the calculation of the porosity is described in the examples). Preference is given to a porosity range from 40 to 95%, particularly preferably from 50 to 90%.

The polymer composition subjected to pyrolysis to produce the carbon foams of the present invention comprises at least 30% by mass, preferably at least 50% by mass and particularly preferably at least 70% by mass, of the above-described polymer foams. Further constituents which may be added to the composition prior to pyrolysis are further polymer materials and/or, for example, fillers. Such fillers are preferably ones which give carbon on pyrolysis, e.g. pitch or carbon in the form of graphite. Good results are achieved by concomitant use of phenolic resins by mixing as yet uncured phenolic resin components into one or more components.

The pyrolysis of the polymer foams is carried out by heating from room temperature to above 500° C., preferably above 800° C., in particular cases up to 3000° C. and above. At particularly high temperatures above 1500° C., the pyrolysis is advantageously carried out under argon or other noble gases and/or under reduced pressure.

Heating is preferably carried out in an atmosphere of nitrogen and/or noble gas, at above 1500° C. particularly preferably in a noble gas atmosphere, if desired in the partial presence of oxygen and/or carbon dioxide, i.e. in the presence of some oxygen and/or carbon dioxide and/or its/their presence for part of the time. The presence of oxygen and/or carbon dioxide is preferably employed in the temperature range from room temperature to 1500° C., in particular from 150 to 600° C., particularly preferably from 250 to 450° C.

According to the present invention, heating is advantageously carried out at heating rates of from 0.05 K/min to 10 K/min, preferably from 1 K/min to 8 K/min. During pyrolysis, the gas streams are passed through the foam at a flow rate of from 0.1 liter per hour to 10 liters per minute and gram of foam used. In a preferred process variant, the maximum pyrolysis temperature is held for from 5 minutes to 2 days.

Cooling is preferably carried out at cooling rates of from 0.05 K/min to 40 K/min, preferably from 15 to 25 K/min, to room temperature.

Quench cooling from a maximum of 2500° C. to room temperature by introduction of the hot carbon foam into an environment at room temperature of about 20-25° C. is also possible.

Furthermore, interruption of the heating-up and cooling by keeping the temperature constant on “ramps” for from 5 minutes to 8 days can also be advantageous.

Generation of the pores according to the present invention having dimensions of from 0.2 nm to 50 nm and a high internal surface area in the cell framework material can also be achieved by targeted action of water vapor and/or carbon dioxide and/or oxygen during the pyrolysis of the polymer foams or by subsequent action of water vapor and/or carbon dioxide and/or oxygen on the finished carbon foam which has previously been produced by pyrolysis in nitrogen and/or noble gas. The treatment with water vapor and/or carbon dioxide and/or oxygen is carried out at above 400° C., with the effect increasing with increasing temperature and increasing concentration.

The internal surface area increases with increasing time of treatment with water vapor, carbon dioxide and/or oxygen, with increasing temperature and with increasing concentration of the gases. However, it is advantageous not to increase the internal surface area above 2000 m²/gram, since the material degradation required for generation of the pores becomes so great that the mechanical properties are seriously impaired. The internal surface area is generated predominantly by these pores having dimensions of from 0.2 to 50 nm.

The treatment with water vapor carried out during pyrolysis is advantageously carried out in the concentration range from 0.5 to 80% by volume, preferably from 10 to 60% by volume and particularly preferably from 20 to 50% by volume, of water vapor in the mixture of water vapor and nitrogen and/or noble gas. The temperature of the water vapor treatment is above 400° C. and preferably below 1200° C., advantageously in the range from 500 to 1100° C., particularly preferably from 600 to 1000° C.

The treatment with carbon dioxide carried out during pyrolysis is advantageously carried out in the concentration range above 1% by volume of carbon dioxide in the mixture of carbon dioxide and nitrogen and/or noble gas. Preference is given to using more than 20% by volume of carbon dioxide, particularly preferably more than 50% by volume. The action is strongest when using pure carbon dioxide. The temperature of the carbon dioxide treatment is above 400° C. and preferably below 1500° C., preferably in the range from 600 to 1300° C., particularly preferably from 700 to 1100° C.

The treatment can be carried out in the simultaneous presence from time to time of oxygen in concentrations of from 0.05 to 30% by volume in the gas mixture in the range from room temperature to 1500° C., preferably from>300 to 1200° C., particularly preferably in the range from 300 to 800° C. The oxygen concentrations are preferably in the range from 1 to 20% by volume, particularly preferably from 3 to 15% by volume. The oxygen can be used in combination with all variants described. It effects an increase in the yield of carbon foam and an increase in the internal surface area. The yield is increased especially by the action of oxygen during pyrolysis of the carbon foam in the range from room temperature to 600° C.

In an analogous manner, the carbon foam can firstly be produced by pyrolysis in nitrogen and/or noble gas and this carbon foam can subsequently be treated with water vapor and/or carbon dioxide and/or oxygen. For this purpose, the fully pyrolyzed carbon foam is subsequently treated at above 500° C. with from 1 to 80% by volume of water vapor in a mixture of water vapor and nitrogen and/or noble gas or at above 500° C. with over 1% by volume, preferably from 5 to 90% by volume, of carbon dioxide in a mixture of carbon dioxide and nitrogen and/or noble gas or with pure carbon dioxide.

A temperatures below 2000° C., preferably below 1700° C., particularly preferably below 1500° C., it is possible to use nitrogen alone or in admixture with a noble gas as inert gas/inert gas mixture. Similarly, nitrogen should no longer be used at above 2000° C., preferably even at above 1700° C. and particularly preferably even at above 1500° C. This also has to be ensured in pyrolysis under reduced pressure.

The novel foams consisting predominantly of carbon and having a high internal surface area are suitable for electrical and electrochemical applications, as filter and heat insulation material, as support and storage material and as starting material for further reactions and also for further applications of carbon foams.

It can advantageously be used, for example, as electrode material in batteries, for electrochemical synthesis, for electrochemical sensors, e.g. enzyme electrodes, in particular as electrode material for supercapacitors or fuel cells, as filter material for liquid metals, e.g. copper, as heat transfer matrix, as column material in chromatography, as starting material for reaction with silicon to form silicon carbide bodies, e.g. for high-performance friction materials or silicon carbide foams, or for reaction with further carbon to give carbon-carbon composites, as heat insulation material for high temperatures, as catalyst support, as heat shield material in spaceflight and as gas storage material.

The pulverulent carbon material is particularly suitable as electrode material for supercapacitors and/or in fuel cells.

The present invention is illustrated by the examples below, without being restricted thereto.

### EXAMPLES

I. Raw Materials Used For Producing the Polymer Foams Based on Isocyanate

1. Isocyanates

Isocyanate 1

Polyisocyanate Lupranat® M50 (BASF), a mixture of diphenylmethane diisocyanate and polyphenyl polyisocyanates having an NCO content of 31.5% by weight and a viscosity of 550 mPas at 25° C.

Isocyanate 2

Polyisocyanate Lupranate® M70 (BASF), a mixture of diphenylmethane diisocyanate and polyphenyl polyisocyanates having an NCO content of 31% by weight and a viscosity of 750 mPas at 25° C.

2. Hydroxyl-containing compounds having ester structures and ether structures, known as polyols

Polyol 1

Polyester alcohol prepared by reaction of adipic acid/phthalic anhydride/oleic acid in a molar ratio of 1:2:1 with 1,1,1-trimethylolpropane and having a number average molar mass of 530 g/mol, a hydroxyl number of 385 mg KOH/g, a viscosity at 75° C. of 1370 mPas and a mean functionality of 3.7.

Polyol 2

Polyether alcohol prepared by reaction of glycerol as starter with propylene oxide as first block and ethylene oxide as end block and having a hydroxyl number of 35 mg KOH/g and a viscosity of 850 mPas at 25° C. The mass ratio of propylene oxide to ethylene oxide is 6.4. The mean molar mass is 4350 g/mol, and the mean functionality is 2.7.

II. Preparation of the Polymer Foams Having Isocyanurate Structures (Tables 1a and 1b)

Foaming in a Cup:

A component: mixture of polyols, catalysts, stabilizers and blowing agents and, if desired, further additives. Fillers can be incorporated into the polyol component.

B component: polyisocyanate or mixture of polyisocyanates. Fillers can be incorporated into the isocyanate component.

A and B components were brought to 20° C.±0.5 K. A total of 78 g of the A and B components were mixed for 10 seconds in a cardboard cup having a capacity of about 660 ml by means of a laboratory stirrer (stirrer speed: 1750 rpm) provided with a stirring head from Vollrath (diameter: 65 mm). The ratio of A to B corresponded to the respective formulation. The cream time, rise time and fiber time were measured on the rising foam, and the foam density, also referred to simply as density in the tables, was measured on the cured foam.

The porosity is calculated from the density of the foam Ds in kg/m³ and the density of the polymer material of 1250 kg/m³:
Porosity in %=[1−Ds/1250]·100.

The open cell content was determined in accordance with ASTM D 2856-87, method C.

The polyisocyanurate content is determined by measuring the ratio of the absorbance of the band at about 1410 cm⁻¹ (isocyanurate) to that of the band at about 1595 cm⁻¹ (aromatic) in the middle infrared region on a pulverized sample prepared by the press potassium bromide pellet technique and reported as “Aᵣ(PIR)”.

The nitrogen content is calculated from the formulation and agrees with the value determined by elemental analysis.

Formulations for producing the polymer foams based on isocyanate
TABLE 1a

| System number | 1 | 2 | 2a | 2b | 2c | 2d | 2e | 3 |
|---|---|---|---|---|---|---|---|---|
| M | B | B | B | B | B | B | B | |
| Polyol 1 | 31.0 | 25.6 | 25.6 | 25.6 | 26.6 | 26.6 | 25.6 | 25.6 |
| Polyol 2 | 45.0 | 31.6 | 31.6 | 31.6 | 31.6 | 31.6 | 31.6 | 31.6 |
| Dipropylene glycol | 18.0 | 16.7 | 16.7 | 16.7 | 16.7 | 16.7 | 16.7 | 16.7 |
| Tegostab ® B8461 ¹) | 1.50 | 1.30 | 1.30 | 1.30 | 1.30 | 1.30 | 1.30 | 1.30 |
| Tegostab ® B8409 ¹) | 1.50 | 1.30 | 1.30 | 1.30 | 1.30 | 1.30 | 1.30 | 1.30 |
| Water/glycerol/ | 3.00 | | | | | | | |
| dipropylene glycol ²) | | | | | | | | |
| Water | — | 0.4 | 0.4 | 0.4 | 0.4 | 0.4 | 0.4 | 0.4 |
| Potassium acetate/ | 5.00 | 5.00 | 5.00 | 5.00 | 5.00 | 5.00 | 5.00 | 5.00 |
| monoethylene glycol ³) | | | | | | | | |
| Triazine ⁴) | 0.50 | | | | | | | |
| Triamine ⁵) | | | | | | | | |
| Copyright by Elastogran GmbH | — | 0.3 | 0.3 | 0.3 | 0.3 | 0.3 | 0.3 | 0.3 |
| Schwarzheide PAE/E, 1996 | | | | | | | | |
| Orthegol 501⁶) | — | 1.00 | 1.00 | 1.00 | 1.00 | 1.00 | 1.00 | 1.00 |
| Calcium carbonate | | | | 55 | | | 5 | — |
| Ammonium polyphosphate | | | | | | 5 | | — |
| Expanded graphite | | | 85 | | | | | — |
| Al(CH₃COO)₂OH | | | | | 5 | | | — |
| n-Pentane | 12.0 | 9.9 | 9.9 | 9.9 | 9.9 | 9.9 | 9.9 | 9.9 |

Table 1b (continuation of Table 1a):

| Number | 1 | 2 | 2a | 2b | 2c | 2d | 2e | 3 |
|---|---|---|---|---|---|---|---|---|
| Isocyanate 1 | — | 388 | 388 | 388 | 388 | 388 | 388 | 388 |
| Isocyanate 2 | 441 | — | — | — | — | — | — | — |
| Cream time in s | 17 | 14 | 15 | 14 | 15 | 16 | 16 | 14 |
| Fiber time in s | 26 | 30 | 55 | 36 | 39 | 36 | 35 | 30 |
| Rise time in s | 40 | 38 | 102 | 51 | 54 | 55 | 59 | 38 |
| Foam density in kg/m³ | 75 | 230.2 | 103.3 | 124.5 | 100.2 | 118.7 | 107.7 | 230.2 |
| Porosity in % | 94 | 82 | 92 | 90 | 92 | 90 | 91 | 82 |
| Open cell content in % | 12 | 81.1 | 15.4 | 89.5 | 93.0 | 93.2 | 93.7 | 81.1 |
| Nitrogen content in % | 8.8 | 8.9 | 8.8 | 8.1 | 8.9 | 8.9 | 8.9 | 8.9 |
| Aᵣ(PIR) | 5.18 | 7.67 | — | 7.32 | — | 5.69 | 5.38 | 7.67 |
| Treatment of the foam | | | | | | | | impreg- |
| | | | | | | | nation | |
| | | | | | | | with | |
| | | | | | | | ZnCl₂ | |

Parts are by mass
C = foaming in a cup
M = foaming by machine: the components were mixed continuously by means of the high-pressure foaming machine PUROMAT ® HD 30 from Elastogran GmbH and subsequently applied by means of a casting rake to a double conveyor belt. This process is described, for example, by R. Wiedermann and R. Zöllner on pages 272-273 in the Kunststoff-Handbuch, volume 7, Polyurethane, edited by G. Oertel and published by Hanser Verlag, Munich, Vienna, 1993.
Conditions in machine experiment: total discharge = 15 000 kg/min. Belt speed: 4.1 m/min.
¹)Th. Goldschmidt AG.
²)Composition in parts by mass (parts): 120 parts of water, 62 parts of dipropylene glycol, 18 parts of glycerol.
³)Composition in parts by mass: 54 parts of monoethylene glycol, 46 parts of potassium acetate.
⁴)1,3,5-Tris (3-dimethylaminopropyl)-hexahydro-s-triazine.
⁵)N,N,N,N,N-Pentamethyldiethylentriamine.
⁶)Liquid relatively high molcular weight unsaturated hydrocarbon as described in DE 4303809, Th. Goldschmidt AG.

III. Production of the Carbon Foams

Characterization of the Carbon Foams:

In all examples, the module tube furnace model GTF 12/50/546/E2408 CP from Carbolite GmbH fitted with a fused silica tube having an internal diameter of 55 mm and a length of 1100 mm was used.

The measurements of the foam density and the open cell content were carried out analogously to those for the polymer foams.

The measurement of the density of the cell framework material (carbon foam matrix) Dg to calculate the porosity was carried out by means of a pycnometer.

The porosity was calculated in % according to the following equation:
Porosity in %=[ 1−Ds/Dg]·100.

Ds: foam density of the carbon foam in kg/m³,

Dg: density of the cell framework material in kg/m³.

This density is the density of the “nanoporous” framework material. The pores in the nanometer range are disregarded in reporting this porosity which is based on the cells >20 μm.

The assessment of the cell strut cross sections was carried out by means of scanning electron microscopy.

The internal surface area was determined in accordance with DIN 66 131 (Langmuir surface area). The dimensions of the pores in the cell framework, reported as pore diameter and the corresponding pore volume of the pores in the nm range, were determined from measurements using a method based on DIN 66 131 and evaluation by the Langmuir/Horvath Kavazoe method.

### EXAMPLE 1

### Comparison

Specimens having the dimensions 6 cm×3.5 cm×1.7 cm and a mass of 2.5 g were sawn from the isocyanate-based polymer foam prepared from system No. 1 in Table 1 and positioned in the module tube furnace in the middle of the fused silica tube. A stream of nitrogen was passed through the tube at a flow rate of 5 l/min during the entire experiment. The specimen was heated to 800° C. at a heating rate of 5 K/min, maintained at the maximum temperature Tmax of 800° C. for one hour and cooled to 30° C. at 20 K/min. This gave a crack-free homogeneous carbon foam having a mass of 0.72 g, i.e. a carbon foam yield of 28.8%. The density of the carbon foam was 105 kg/m³, the carbon content was 79% by weight, the nitrogen content was 9.5% and the hydrogen content was 2.5% by weight. The density of the framework material was 1.6 g/cm³, the porosity was 92.5% and the open cell content was 93%. The internal surface area was measured as 4.1 m²/g in accordance with DIN 66131.

### EXAMPLE 1a

### According to the Present Invention

The carbon foam produced as described in Example 1 was once again positioned in the module tube furnace in the middle of the fused silica tube. A stream of nitrogen was passed through the tube at a flow rate of 5 l/min during the entire experiment. The specimen was heated to 800° C. at a heating rate of 5 K/min, then treated with 2 l/min of nitrogen plus 1.2 l/min of water vapor for 30 minutes at the maximum temperature Tmax of 800° C. and cooled to 30° C. at 20 K/min. The loss in mass was 16%, based on the mass of the carbon foam used.

### EXAMPLE 1b

### According to the Present Invention

The carbon foam produced as described in Example 1 was once again positioned in the module tube furnace in the middle of the fused silica tube. A stream of nitrogen was passed through the tube at a flow rate of 5 l/min during the experiment. In the temperature interval from 300 to 500° C., 5 l/min of air were passed through the furnace in place of the nitrogen. The specimen was heated further to 800° C. at a heating rate of 5 K/min, then treated with 2 l/min of nitrogen plus 1.2 l/min of water vapor for 15 minutes at the maximum temperature Tmax of 800° C. and cooled to 30° C. at 20 K/min. The loss in mass was 18%, based on the mass of the carbon foam used.

### EXAMPLE 1c

### According to the Present Invention

The carbon foam produced by the method of Example 1 was positioned in the module tube furnace in the middle of the fused silica tube. A stream of nitrogen was passed through the tube at a flow rate of 5 l/min during the experiment. In the temperature interval from 650 to 750° C., 2 l/min of nitrogen plus 0.44 l/min of water vapor were passed through the furnace in place of the pure nitrogen. In this way, the water vapor treatment occurred simultaneously with the pyrolysis. The specimen was treated for a further 30 minutes in pure nitrogen at a flow rate of 5 l/min at a constant 750° C. The loss in mass was 75.1%, based on the mass of the carbon foam used.

### EXAMPLE 1d

### According to the Present Invention

The carbon foam produced as described in Example 1 was again positioned in the module tube furnace in the middle of the fused silica tube. A stream of nitrogen was passed through the tube at a flow rate of 5 l/min during the experiment. Heating rate 5 K/min. In the temperature interval from 800 to 900° C., 2 l/min of nitrogen plus 1 l/min of carbon dioxide were passed through the furnace in place of the pure nitrogen at 2 K/min. At 900° C., the temperature was kept constant for 1 hour at the abovementioned gas flow. The loss in mass was 9.1%, based on the mass of the carbon foam used.

### EXAMPLE 1e

### According to the Present Invention

The carbon foam produced by the method of Example 1 was positioned in the module tube furnace in the middle of the fused silica tube. A stream of nitrogen was passed through the tube at a flow rate of 5 l/min during the experiment. Heating rate: 5 K/min. In the temperature interval from 800 to 900° C., 2 l/min of nitrogen plus 1 l/min of carbon dioxide were passed through the furnace in place of the pure nitrogen. In this way, the carbon dioxide treatment occurred simultaneously with the pyrolysis. At 900° C., the temperature was kept constant for 1 hour at the abovementioned gas flow. The loss in mass was 74.0%, based on the mass of the carbon foam used.

### EXAMPLE 2

### Comparison

Specimens having the dimensions 6 cm×3.5 cm×1.7 cm and a mass of 9.2 g were sawn from the isocyanate-based polymer foam prepared from system No. 2 in Table 1 and positioned in the module tube furnace in the middle of the fused silica tube. A stream of nitrogen was passed through the tube at a flow rate of 5 l/min during the experiment. The specimen was heated to 500° C. at 3 K/min and subsequently to 800° C. at 5 K/min. The hold time at 800° C. under nitrogen was 10 minutes. The loss in mass was 68%, based on the mass of the polymer foam used.

### EXAMPLES 2a, 2b, 2c, 2d and 2e

### According to the Present Invention

These examples illustrate the effect of incorporated fillers (basic aluminum acetate, expanded graphite, calcium carbonate and ammonium polyphosphate) on the internal surface area.

The polymer foams of Examples 2a, 2b and 2c were prepared from the respective systems Nos. 2a to 2c in Table 1. Specimens having dimensions of 6 cm×3.5 cm×1.7 cm were sawn from the foams and positioned in the module tube furnace in the middle of the fused silica tube. They were heated under 5 l/min of nitrogen to 500° C. at 3 K/min and subsequently to 800° C. at 5 K/min. The hold time at 800° C. under nitrogen was 10 min. The loss in mass was 70% (2a) or 62% (2b) or 63% (2c), based on the mass of the polymer foam used.

The polymer foams of Examples 2d and 2e were treated with nitrogen/water vapor by a method analogous to Example 1c. The loss in mass was 69% (2d) or 72% (2e), based on the mass of the polymer foam used.

### EXAMPLE 3

### According to the Present Invention

The polymer foam prepared as described in Example 2 was impregnated with a 1 molar solution of zinc chloride in diethyl ether under reduced pressure and subsequently dried. In this way, 34.4% by mass of ZnCl₂ were placed on the surface of the foam. The foam which had been treated in this way was heated to 900° C. in the module tube furnace at 5 K/min under 5 l/min of nitrogen. The loss in mass was 68.1%, based on the mass of the polymer foam used.

### EXAMPLE 4

### According to the Present Invention

The polymer foam based on melamine resin (Basotect® BASF) was positioned in the module tube furnace in a manner analogous to Example 1e. A stream of nitrogen was passed through the tube at a flow rate of 5 l/min during the experiment. The heating rate was 5 K/min. In the temperature interval from 800 to 900° C., 2 l/min of nitrogen plus 1 l/min of carbon dioxide were passed through the furnace in place of the pure nitrogen at 2 K/min. At 900° C., the temperature was kept constant for 1 hour at the abovementioned gas flow. The loss in mass was 61.0%, based on the mass of the polymer foam used.

TABLE 2
Carbon foams

| Example | 1 | 1a | 1b | 1c | 1d | 1e | 2 | 2a | 2b | 2c | 2d | 2e | 3 | 4 |
|---|---|---|---|---|---|---|---|---|---|---|---|---|---|---|
| Foam from | 1 | 1 | 1 | 1 | 1 | 1 | 2 | 2a | 2b | 2c | 2d | 2e | 2 | — |
| Tab. 1a/1b | | | | | | | | | | | | | | |
| used | | | | | | | | | | | | | | |
| Density of the | 105 | 74 | 72 | 68 | 83 | 81 | 265 | 95 | 117 | 110 | 132 | 110 | 120 | 15 |
| Tab. 1a/1b | | | | | | | | | | | | | | |
| in kg/m³ | | | | | | | | | | | | | | |
| Porosity | 93 | 95 | 95 | 95 | 95 | 95 | 83 | 94 | 93 | 93 | 92 | 93 | 93 | 99 |
| in % | | | | | | | | | | | | | | |
| Density of the | 1.60 | 1.46 | 1.48 | 1.45 | 1.56 | 1.58 | 1.60 | 1.60 | 1.60 | 1.60 | 1.58 | 1.58 | 1.70 | 1.60 |
| C foam matrix | | | | | | | | | | | | | | |
| in g/cm³ | | | | | | | | | | | | | | |
| Surface area in | 4.1 | 793 | 905 | 559 | 1015 | 649 | 2.4 | 128 | 55 | 57 | 571 | 394 | 131 | 685 |
| m²/g | | | | | | | | | | | | | | |
| determined in | | | | | | | | | | | | | | |
| accordance | | | | | | | | | | | | | | |
| with | | | | | | | | | | | | | | |
| DIN 66 131 | | | | | | | | | | | | | | |
| Dimensions of | — | 4.5 | 10.3 | 2.5 | 1.32 | 1.29 | — | 2.5 | 3.0- | 4.5 | 6.5 | 7.5- | 4.0 | 10.5 |
| the pores in the | | | | | | | | | | | | | | |
| cell framework | | | | | | | | | | | | | | |
| as pore radius | | | | | | | | | | | | | | |
| in nm | | | | | | | | | | | | | | |
| Pore volume of | — | 0.53 | 0.6 | 0.55 | 0.41 | 0.20 | — | 0.15 | 0.2 | 0.3 | 0.4 | 0.5 | 0.2 | 0.5 |
| the pores in the | | | | | | | | | | | | | | |
| cell framework | | | | | | | | | | | | | | |
| in cm³/g | | | | | | | | | | | | | | |

In the comparative experiments, the internal surface areas of the carbon foams are far below the value according to the present invention of 50 m²/g, so that an analysis of pore sizes and volumes is superfluous.

1. A process for producing a foam comprising at least 70% by weight of carbon by pyrolysis of polymer foams which comprise at least 30% by mass of a polymer material having a nitrogen content of more than 6% by mass and having a porosity of from 35% to 99.5% and an open cell content above 1%, have inorganics selected from the group consisting of zinc chloride, calcium carbonate, ammonium polyphosphate, expanded graphite and metal powders incorporated into the polymer foam and/or applied to the surface and/or are treated during and/or after the pyrolysis with water vapor and/or carbon dioxide at above 400° C.

2. The process as claimed in claim 1, wherein the polymer foams comprise urea-formaldehyde resins.

3. The process as claimed in claim 1, wherein the polymer foams comprise melamine-formaldehyde resins.

4. The process as claimed in claim 1, wherein the polymer foams comprise polymeric isocyanate adducts.

5. The process as claimed in claim 4, wherein the polymeric isocyanate adducts comprise polyisocyanurate structures which have a ratio Aᵣ of the absorbance of the isocyanurate band in the middle infrared region at about 1410 cm⁻¹ recorded by the pressed potassium bromide pellet technique after preparation to the absorbance of the aromatic bands at about 1600 cm⁻¹ of greater than 1.5.

6. The process as claimed in claim 4, wherein the polymeric isocyanate adducts used are prepared by reacting polyisocyanates with themselves, with compounds containing hydrogen-active groups or with further compounds which react with isocyanate in the presence of catalysts, stabilizers, blowing agents and, if desired, further auxiliaries.

7. The process as claimed in claim 6, wherein hydroxyl-containing polymerization products having a molar mass of greater than 200 g/mol und a functionality of greater than 1 are used as compounds containing hydrogen-active groups.

8. The process as claimed in claim 6, wherein polyesterols based on aromatic polycarboxylic acids and polyfunctional alcohols are used as compounds containing hydrogen-active groups.

9. The process as claimed in claim 4, wherein the further compounds which react with isocyanate contain organic acid anhydride structures.

10. The process as claimed in claim 4, wherein the further compounds which react with isocyanate contain epoxide structures.

11. The process as claimed in claim 1, wherein at least one compound having a crown ether structure is used as catalyst.

12. The process as claimed in claim 1, wherein as yet uncured phenolic resin components are employed in addition to the polymer foams used.

13. The process as claimed in claim 1, wherein inorganic salts, metal powders or expanded graphite are used as fillers in the preparation of the polymer foams used in an amount of from 0. 1% by mass to 60% by mass, based on the total mass of the polymer foams.

14. The process as claimed in claim 1, wherein the polymer foams used are impregnated with solutions or dispersions of inorganic salts, metal powders or expanded graphite in water or organic solvents in such a way that an amount of from 0. 1% by mass to 60% by mass of the inorganics remains on the foam after evaporation of the solvent.

15. The process as claimed in claim 1, wherein the inorganic salts used are zinc chloride and/or calcium carbonate and/or ammonium polyphosphate.

16. The process as claimed in claim 1, wherein the pyrolysis of the polymer foams is carried out by heating from room temperature to over 500° C. and above 500° C. to a temperature of 3000° C.

17. The process as claimed in claim 1, wherein heating is carried out at heating rates of from 0.05 K/min to 10 K/min during the pyrolysis.

18. The process as claimed in claim 1, wherein the pyrolysis of the polymer foams is carried out in an atmosphere of nitrogen and/or noble gases.

19. The process as claimed in claim 1, wherein the pyrolysis of the polymer foams is carried out by heating from room temperature to a temperature in the range from 400° C. to 1200° C. in nitrogen and/or noble gas and at higher temperatures in a mixture of water vapor with nitrogen and/or noble gas containing from 0.5% by volume to 80% by volume of water vapor.

20. The process as claimed in claim 1, wherein the pyrolysis of the polymer foams is carried out by heating from room temperature to a temperature in the range from 400° C. to 1500° C. in nitrogen and/or noble gas and at higher temperatures in a mixture of carbon dioxide and nitrogen and/or noble gas containing over 1% by volume of carbon dioxide.

21. The process as claimed in claim 1, wherein the pyrolysis of the polymer foams is carried out by heating from room temperature to a temperature in the range from 400° C. to 1500° C. in nitrogen and/or noble gas and at higher temperatures in carbon dioxide.

22. The process as claimed in claim 1, wherein the foam comprising at least 70% by weight of carbon is firstly produced by pyrolysis in nitrogen and/or noble gas and is subsequently treated at above 500° C. with a mixture of water vapor and nitrogen and/or noble gas containing from 1% by volume to 80% by volume of water vapor.

23. The process as claimed in claim 1, wherein the foam comprising at least 70% by weight of carbon is firstly produced by pyrolysis in nitrogen and/or noble gas and is subsequently treated at above 500° C. with a mixture of carbon dioxide and nitrogen and/or noble gas containing over 1% by volume of carbon dioxide.

24. The process as claimed in claim 1, wherein the foam comprising at least 70% by weight of carbon is firstly produced by pyrolysis in nitrogen and/or noble gas and is subsequently treated at above 500° C. with carbon dioxide.

25. The process as claimed in claim 1, wherein the pyrolysis of the polymer foams is carried out in the temperature range from room temperature to 1500° C. in the presence of oxygen in an amount of from 0.05% by volume to 30% by volume, based on the total amount of gas.

26. The process as claimed in claim 1, wherein the flow rate of the gas streams during the pyrolysis or the after-treatment of the foam comprising at least 70% by weight of carbon is from 0.01 liter per hour to 10 liters per minute and gram of foam.

27. A foam comprising at least 70% by weight of carbon and having a mean cell size above 20 μm, a porosity based on this cell size of from 35% to 99.5% and an open cell content above 90%, an internal surface area above 50 m²/g, having cell struts whose cross section is a triangle having concave sides and having pores in the cell framework material having dimensions of from 0.2 nm to 50 nm and a volume of from 0.01 cm³/g to 0.8 cm³/g, produced according to claim 1.

28. A method comprising utilizing the foam as claimed in claim 27 for electrical and electrochemical applications, as filter and thermal insulation material, as support and storage material and as starting material for further reactions.

29. A method comprising utilizing the foam as claimed in claim 27 as electrode material for supercapacitors and/or in fuel cells.

30. A method comprising utilizing a pulverulent material obtained from a foam produced by the process as claimed in claim 7 as an electrode material for supercapacitors and/or fuel cells.
